(19) United States
(12) Patent Application Publication
(10) Pub. No.: US 2006/0009929 A1
(43) Pub. Date: Jan. 12, 2006

(54) In-service insulated tank certification

(76) Inventors: Roger Lewis Boyette JR., Lake Charles, LA (US); Castille Anthony Hebert, Lake Charles, LA (US); Mihai Nedelea, Sulphur, LA (US); Thomas Wayne Woodell, Lake Charles, LA (US); Alirio Jose Zambrano, Lake Charles, LA (US)

Correspondence Address: Roger Boyette, PO Box 29, Sulphur, LA, 70664, US

(21) Appl. No.: 10/886,786

(22) Filed: Jul. 6, 2004

(51) Int. Cl. G01F 17/00

(52) U.S. Cl. 702/55

(57) ABSTRACT

A method for the accurate measurement of the true dimensions and true geometric shape of an insulated, or otherwise wrapped tank, and for the subsequent calculation of the strapping table (strap chart) thereof, for any desired liquid height increment, without removing the wrapping (insulation), or draining and cleaning the tank on the inside. A number of points are identified and located on the tank shell, for which 3D coordinates measurement is desired. A target is used for each desired measurement point. The method uses a total station to determine the 3D coordinates of a minimum of 3 points on a reflective target. The target is attached to a bolt that can be threaded through the tank insulation until the end of the bolt makes snug contact with the tank shell. The 3D coordinates of the 3 points on the target, measured with the total station, are converted to the coordinates of the point of contact between the tank shell and the tip of the bolt, which could not be sighted or measured otherwise, being covered by the insulation.

### BACKGROUND OF THE INVENTION

### FIELD OF THE INVENTION

The invention relates generally to the procedures for generating a strap chart or strapping table for accurately reading the volume of the liquid contained in a tank for each known value of the liquid level in the tank. The generation of this strapping chart is usually called tank certification. More particularly, this invention relates to a procedure to determine the profile in as many horizontal or vertical cross sections as desired, for a tank that can be insulated and can contain hot liquids, while the tank is in operation, by using a total station using electronic distance measurement, whereby the light beam, which can be a laser beam, is reflected not directly by the surface of the measured object, but by a target or system of targets which have the ability to penetrate the insulation and make contact to the tank shell. To conclude the procedure, the 3D or 2D coordinates of the profiles thus measured are mathematically converted into a strapping table or strap chart.

### APPLICABLE U.S. PATENT CLASSIFICATION DEFINITIONS

702/55, 85, 127, 152, 156, 157, 167;

356/4.08, 141.2, 152.2, 602, 603, 620, 627;

73/861, 290R

### DESCRIPTION OF THE PRIOR ART

In numerous applications, a need exists for the ability to calculate the volume of the liquid content of a tank, regardless of the tank's shape, from the height of the liquid level inside it. In the general case, even if the tank is of a cylindrical shape, this relationship is not linear, due to numerous factors, such as the warping of the tank shell under mechanical loads, the bulging under hydrostatic head, or similar.

Thus arises the need for a strapping table, or strap chart, which is a document that shows, in tabular form, the correspondence between the liquid level height and the volume of the liquid contained, for a steady increment, which is determined based on the accuracy required by the application. For example, the accuracy of the measurement required by the American Petroleum Institute (API's Manual of Petroleum Management Standard, Chapter 2—Tank Calibration) is ±0.01 ft for a circumference up to 150 ft, or ±0.007%, which is very tight. Sometimes the generation of the strapping table is called tank certification.

Presently, several different procedures are available for generating the strap chart (also called tank calibration) of a liquid containing tank. One of them is manual strapping, as outlined in the same source (1), whereby a measuring tape is strapped around the tank circumference at several elevations, the measured circumference values are converted into diameter values, and corrections for thermal expansion and deformation under hydraulic head are applied. The incremental volume of the tank is then calculated based on the diameter measured and corrected for each respective elevation. The results are eventually recorded in the strap chart.

A second procedure, also outlined by the American Petroleum Institute Manual (1), consists of measuring the real tank circumference by using the optical-triangulation method, in two possible settings: from the inside, or from the outside. The inside setting is of limited practicality, since it can only be applied when the tank is empty and completely cleaned, which implies high cleaning costs and production down time. The outside method consists of setting up an optical theodolite in several locations around the tank, and sighting the tank walls tangentially from each location, both sides, at a number of elevations which depends on the total tank height. The total number of theodolite setups depends on the tank diameter. The distances thus triangulated are then converted in 3D coordinates of points on the outside shell of the tank. For each respective elevation, the 3D coordinates are mathematically processed to calculate an equivalent internal diameter. The incremental volume of the tank is then calculated based on the diameter corrected for each respective elevation. The results are eventually recorded in the strap chart.

The available patent literature includes several other examples of methods used for determining volumes of tanks, or, more generally, 3D bodies. Some refer to filling the tank with precisely metered volumes of liquid and measuring the changes in liquid height, such as U.S. Pat. No. 5,363,093 to Williams et al., or U.S. Pat. Nos. 5,665,895; 4,977,528, and 6,029,514 to Hart et al. These are typically applicable to fuel tanks located on vehicles, where the total volume of the liquid contained is less important than defining to benchmark levels considered “full” and “needs refilling” respectively. Using optical sensors to measure levels and enable volume element counting, as shown in U.S. Pat. No. 6,690,475 to Spillman Jr. et al., although adequate for tanks of irregular shapes such as aircraft fuel tanks, is not practical for large tanks in other applications due to the prohibitive costs and maintenance problems. Another patented method, using the measurement of the attenuation of X-Rays directed through a package to evaluate its volume (U.S. Pat. No. 6,347,131 to Gusterson), is probably limited to the food industry due to the problems related to using X-Rays on large objects.

A great number of patents refer to various optical tools and systems for measuring and surveying large 3D objects. Some are using reflective targets of elaborate construction to measure distances, mostly prisms and corner cubes, such as the devices described in U.S. Pat. No. 6,324,024 to Shirai et al., U.S. Pat. No. 5,392,521 to Allen, Michael, U.S. Pat. No. 4,875,291 to Panique, et al., and U.S. Pat. No. 4,470,664 to Shirasawa, Akishige. U.S. Pat. No. 6,683,693 to O Tsuka et al., describes an L-shaped target for use in a non-prism light wave range finder, whereby the reflective surface consists of a reflective tape, sheet, or layer of small glass beads. All these patented targets share the common feature of being built and intended to be used on top of a surveyor's pole or similar for the purpose of land survey, and be recovered after each job.

Among other optical methods and systems are: the use of photogrammetry, as shown in U.S. Pat. No. 6,539,330 Wakashiro, Shigeru or U.S. Pat. No. 5,642,293 to Manthey, et al.; the usage of a slit light beam to be directed onto the work to be measured (U.S. Pat. No. 4,961,155 to Ozeki, et al.), the distance triangulation through pixel modulation (U.S. Pat. No. 6,504,605 to Pedersen, et al.), the optical distance measurement using as a target a sphere made of transparent material and the refraction of light through it (U.S. Pat. No. 5,771,099 to Ehbets, Hartmut), measuring a volume through laser scanning (U.S. Pat. No. 6,442,503 to Bengala, Moreno), the measurement of the dimensions of a large object, such as a car chassis, by using optical beams and the travel of the measuring unit on rails around the object (U.S. Pat. No. 5,721,618 to Wiklund, Rudolf).

Other optical measuring procedures involve optical transceivers on a frame, whereby the object is touched with a hand-held measuring probe (U.S. Pat. No. 5,305,091 to Gelbart et al.), and the 3D measurement of the coordinates of various points on an object without reflecting prisms (U.S. Pat. Nos. 5,054,911 and 6,473,166 to Ohishi et al.). The idea of measuring the volume of the tank from the interior is also present, as in U.S. Pat. No. 4,019,034 to Blom et al., and U.S. Pat. No. 6,172,754 to Niebuhr, Erik (the latter implies the laser measurement of the coordinates of 200,000 points inside the tank).

A multitude of optical tools to be applied in these procedures, such as lasers or regular light survey instruments, have been invented and patented. Laser survey instruments are depicted in U.S. Pat. No. 5,946,087 to Kasori et al., 5,859,693 to Dunne et al., U.S. Pat. No. 6,249,338 to Ohtomo et al. Other optical instruments for the contactless measurement of distances have been patented by Neukomm, et al. (U.S. Pat. No. 4,647,209), and Yoshida (U.S. Pat. No. 6,226,076). Total stations are covered by U.S. Pat. Nos. 6,532,059 and 6,501,540 to Shirai, et al., U.S. Pat. No. 6,078,285 to Ito, and U.S. Pat. No. 5,233,357 to Ingensand, et al.

Except for the first two, most procedures mentioned above have been conceived for civil engineering and land surveying purposes. While some of them could be used to measure the outer surface of a large industrial tank, none can be applied to the situation of a tank where the shell is thermally insulated or otherwise wrapped, without either emptying and cleaning the tank so it could be measured from the inside, or completely removing the insulation or other wrapping to enable measurement of the shell from the outside.

### REFERENCES CITED

### U.S. Patent Documents

| Patent No. | Date | Inventors | Current US Class |
|---|---|---|---|
| 4,019,034 | Apr. 19, 1977 | Blom et al. | 702/156 |
| 4,470,664 | Sep. 11, 1984 | Shirasawa, Akishige | 359/529 |
| 4,647,209 | Mar. 03, 1987 | Neukomm et al. | 356/602 |
| 4,875,291 | Oct. 24, 1989 | Panique et al. | 33/293 |
| 4,961,155 | Oct. 02, 1990 | Ozeki et al. | 702/152 |
| 4,977,528 | Dec. 11, 1990 | Norris, Stephen | 702/100 |
| 5,054,911 | Oct. 08, 1991 | Ohishi et al. | 356/5.07 |
| 5,233,357 | Aug. 03, 1993 | Ingensand et al. | 342/352 |
| 5,305,091 | Apr. 19, 1994 | Gelbart et al. | 356/620 |
| 5,363,093 | Nov. 08, 1994 | Williams et al. | 340/605 |
| 5,392,521 | Feb. 28, 1995 | Allen, Michael | 33/293 |
| 5,642,293 | Jun. 24, 1997 | Manthey et al. | 702/42 |
| 5,665,895 | Sep. 09, 1997 | Hart et al. | 73/1.73 |
| 5,721,618 | Feb. 24, 1998 | Wiklund, Rudolf | 356/620 |
| 5,771,099 | Jun. 23, 1998 | Ehbets, Hartmut | 356/620 |
| 5,859,693 | Jan. 12, 1999 | Dunne et al. | 356/4.01 |
| 5,946,087 | Aug. 31, 1999 | Kasori et al. | 356/249 |
| 6,029,514 | Feb. 29, 2000 | Adam et al. | 73/149 |
| 6,078,285 | Jun. 20, 2000 | Ito, Yasuhiro | 342/357.17 |
| 6,172,754 | Jan. 09, 2001 | Niebuhr, Erik | 356/602 |
| 6,226,076 | May 01, 2001 | Yoshida, Hisashi | 356/5.06 |
| 6,249,338 | Jun. 19, 2001 | Ohtomo et al. | 356/4.08 |
| 6,324,024 | Nov. 27, 2001 | Shirai et al. | 359/884 |
| 6,347,131 | Feb. 12, 2002 | Gusterson, Stephen. | 378/54 |
| 6,442,503 | Aug. 27, 2002 | Bengala, Moreno | 702/156 |
| 6,473,166 | Oct. 29, 2002 | Ohishi et al. | 356/141.1 |
| 6,501,540 | Dec. 31, 2002 | Shirai et al. | 356/5.1 |
| 6,504,605 | Jan. 07, 2003 | Pedersen, et al. | 702/152 |
| 6,532,059 | Mar. 11, 2003 | Shirai et al. | 356/3.04 |
| 6,539,330 | Mar. 25, 2003 | Wakashiro, Shigeru | 702/152 |
| 6,683,693 | Jan. 27, 2004 | O Tsuka et al. | 356/620 |
| 6,690,475 | Feb. 10, 2004 | Spillman J R et al. | 356/627 |

### OTHER REFERENCES

American Petroleum Institute: Manual of Petroleum Management Standard: Chapter 2: Tank Calibration

Leica TPS1100 Professional Series total station product information.

### BRIEF SUMMARY OF THE INVENTION

It is therefore an object of the present invention to provide a procedure, or method, for the inexpensive measurement of the true dimensions of an insulated, or otherwise wrapped, tank, and subsequent calculation of the strapping table (strap chart) thereof. The procedure enables the measurement of the tank at a sufficient number of locations to meet the requirements of the API Manual of Petroleum Management or any other requirements, without removing the insulation or wrapping, and without having to drain the tank empty and clean it on the inside. The measurement can be done with any total station or other type of optical instrument that can measure the distance from the instrument to a particular target and the angular position of that target versus the instrument.

Another object is to provide a new and inexpensive design for a specific non-prismatic reflective target that can be used with an optical 3D measurement system in the process of surveying and measuring large objects from the outside. The targets are designed and built to penetrate the thermal insulation or wrapping of tanks intended to contain liquids that can be hot, while at the same time making direct contact to the shell of the tank, thus enabling the mathematical conversion of the coordinates of the targeted area into the coordinates of the respective point of contact on the shell.

Another object is to combine the utilization of a total station or other optical 3D surveying system with a system of targets to enable an accurate measurement and determination of the tank profile in as many horizontal or vertical sections as desired, particularly in cases where the tank is wrapped in material whose thickness is unknown, such as thermal insulation, or whose surface is non-reflective. Thus, this invention offers the following advantages:

It enables the accurate measurement of the true profile of a tank where the reflection of light beams directly from its surface is not possible.

It eliminates the need of removing the insulation or draining the tank empty for the purpose of measurement, thus eliminating important tank downtime costs.

It provides a new type of target that can be used to penetrate wrappings, and thus can be used on surveying other wrapped items as the need arises.

### BRIEF DESCRIPTION OF THE SEVERAL VIEWS OF THE DRAWING

FIG. 1 is a front view of the target used in applying the procedure. It is a general layout at the same time and includes a list of the components, which make up the target (Bill of Materials).

FIG. 2 is a side view of the target in operating position (attached to the tank wall).

FIG. 3 is a top view of the target in operating position (attached to the tank wall).

FIG. 4 is a detail showing the mechanism by which the target assembly attaches to the tank wall and to the insulation siding.

FIG. 5 is a side view of the target cover.

FIG. 6 is a top view of the target cover.

FIG. 7 is a section of the knurled rivet nut used to attach the target to the insulation siding, before installation.

FIG. 8 is a section of the knurled rivet nut used to attach the target to the insulation siding, after installation.

### DETAILED DESCRIPTION OF THE INVENTION

The invention consists of a new procedure, or method, for obtaining the strap chart (strapping table) of a tank containing liquids. This method will be called in the following the In-Service Insulated Tank Certification Procedure. The strap chart is a table where a user can read the volume of the liquid contained in the tank for each increment of the liquid level in the tank. The American Petroleum Institute requires that the increment of the liquid level column be maximum 1 inch. However, the procedure can be used to generate strapping tables with lower increments as well. The accuracy provided by the procedure is equal to the accuracy of the total station used. In the preferred embodiment of this invention, a Leica TPS 1100 Professional Series total station was used, with an accuracy of distance measurement of 2 mm per 250 m, or 1/64 inches per 150 ft, which exceeds 8 times the American Petroleum Institute accuracy requirement of 0.01 ft, or ⅛ inches per 150 ft.

The total station is used in a manner that is similar up to a point to the measurement procedure described in the API Manual of Petroleum Management Standards, Chapter 2, Section 2C—Calibration of Upright Cylindrical Tanks Using the Optical-Triangulation Method. Depending of the size of the tank and the accuracy desired, a density of the measurement points in the vertical and circumferential directions is selected. Some regulatory documents might require that the measurement points be located within a certain space of the vertical or horizontal weld seams of the tank. A map of the points to be measured (surveyed) can be generated per the same API procedure cited above. The total station is set up in several locations around the tank. The distance between locations, and between each location and the tank is large enough to allow the convenient sighting of all the required measurement points in the vertical direction, but at the same time within the measuring range of the instrument. Unlike the API procedure however, no triangulation is performed. The total station delivers the 3D coordinates of each measurement point directly.

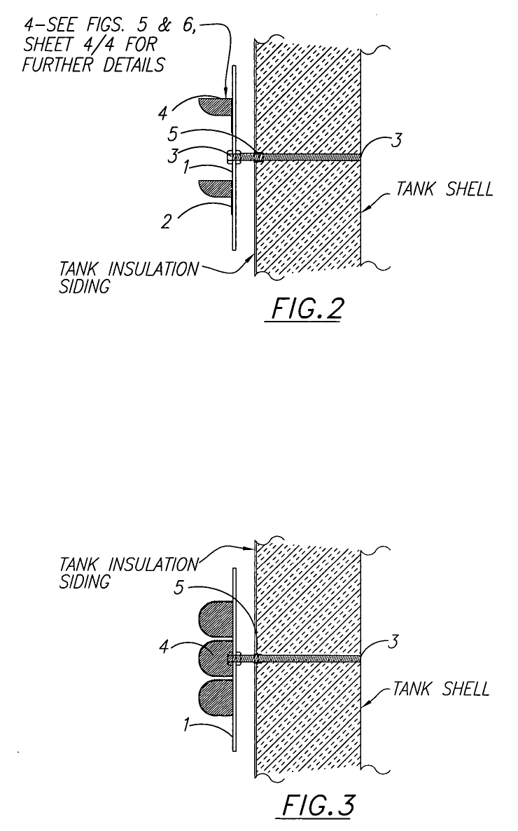

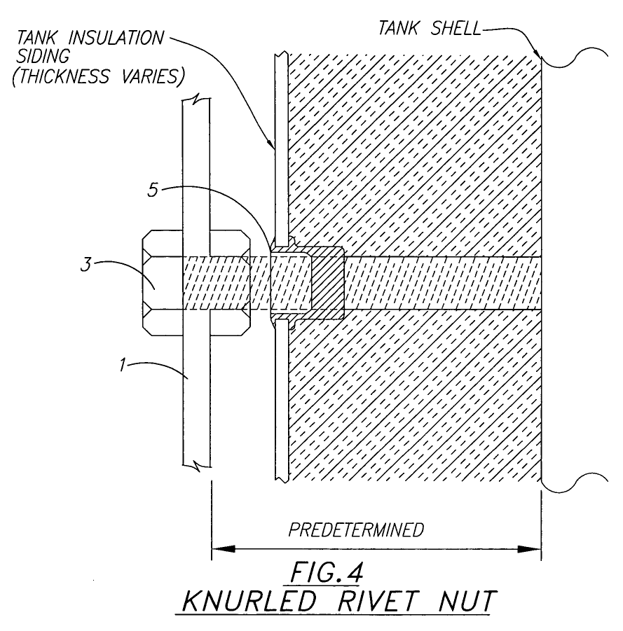

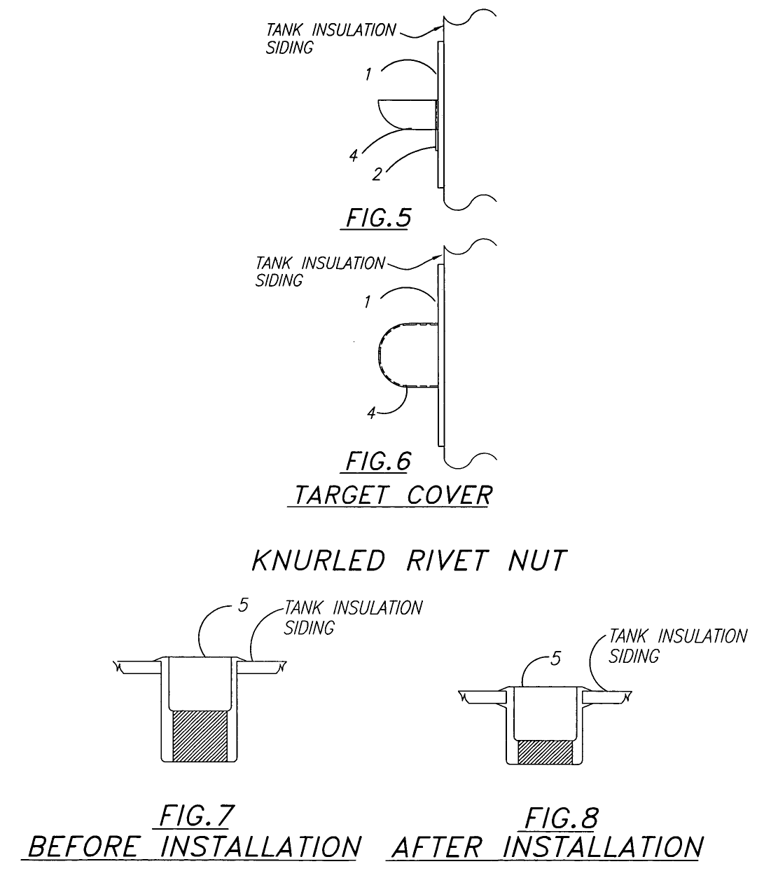

Because the tank is insulated, the measurement points on the outside shell of the tank cannot be sighted directly by the optical beam. This is one of the improvements to the existing state of the art brought by this invention. Each measurement point is covered with a layer of thermal insulation, which is in its turn contained by a sheet of aluminum or similar metal siding. The metal siding can be corrugated or not. A reflective target (1), built according to the drawings attached, is assigned to each measurement point and used as an intermediary piece between it and the total station, to enable the determination of the 3D coordinates of the measurement point. FIGS. 2 and 3 show, in side and top view, how the target (1) is attached to a bolt (3), which is threaded into the mass of the insulation until it reaches the shell of the tank. FIG. 4 shows that the bolt (3) has a predetermined, known length. Because the distance between the metal siding and the shell of the tank is not known, and can vary significantly with corrugated insulation, a knurled rivet nut is used as an attachment piece between the target bolt (3) and the insulation siding. Before threading the bolt (3) through the insulation, a round hole is made in the insulation siding at the desired location. A knurled nut (5) is pushed through the hole and expanded by means of an expanding tool. FIGS. 7 and 8 show the knurled nut (5) before and after the installation. The bolt (3) is then threaded through the knurled nut (5) and the insulation until its end touches the tank shell.

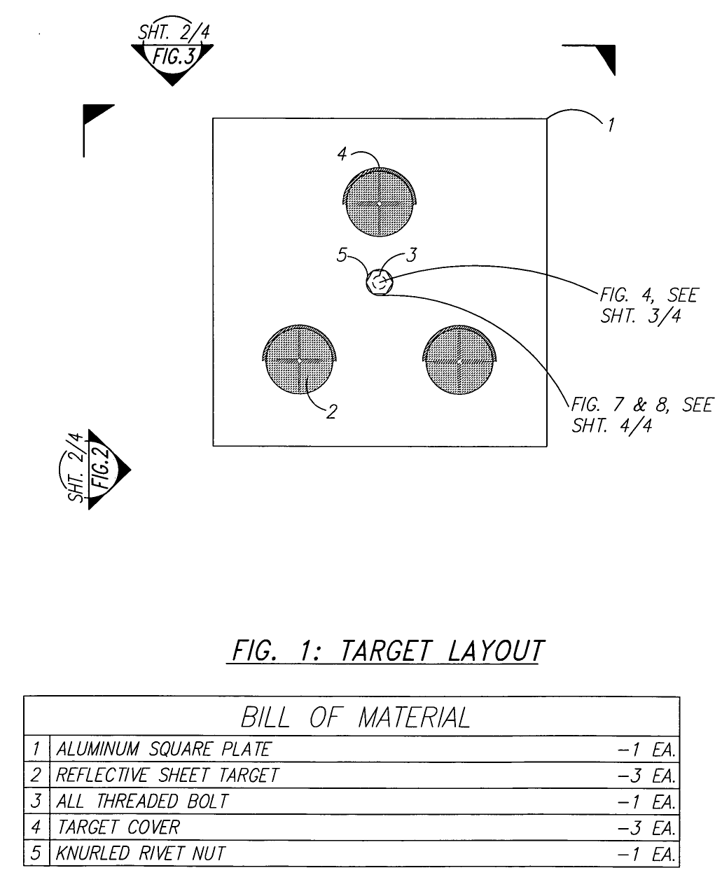

As shown in the attached drawings, especially in FIG. 1, there are 3 reflective areas (2) on the face of the target. The reflective properties of the areas are enhanced by using Leica reflective sheets, or any similar product. In the preferred embodiment of this invention, shown in FIG. 1, the reflective areas are circular, but in other embodiments they can be of any other shape as long as their area is large enough to allow the convenient sighting of the total station light beam. Similarly, in the preferred embodiment of this invention, the target (1) is shown in FIG. 1 as being square, but in other embodiments they can be of any other shape as long as it allows the convenient location of the 3 reflective areas. Similarly, in the preferred embodiment of this invention, the reflective areas (2) are shown in FIG. 1 as being located in the vertices of an equilateral triangle, but in other embodiments any relative locations and distances between them are possible as long as their are known by the person doing the measurements and factored in the formula for calculating the 3D coordinates of the measurement point. The reflected areas are protected against glare by means of the target covers (4).

Once all targets (1) are thus securely attached to the insulation siding and their bolts (3) abut the tank shell underneath the insulation, the total station is used to measure and record the 3D coordinates of each of the targets. In the measurement process, each target is sighted 3 times, and 3 sets of 3D coordinates are recorded. These are the 3D coordinates of the respective points on each reflective area (2), where the total station beam was focused. The 3 sets of coordinates are recorded in a computer spreadsheet for each measurement point. An example printout of such a spreadsheet is attached as Table 1. The spreadsheet is programmed to determine the general 3D equation of the plane generated by the 3 sets of coordinates found, thus calculating the actual equation of the plane made by the target (1) in space. At the same time, the 3D coordinates of the geometric center of the target are calculated by the spreadsheet by means of analytic geometry equations. In the embodiment shown in FIG. 1, this point would be the center of the circle circumscribed to the 3 reflective areas (2). In other embodiments, its position may be different.

As indicated above, the absolute distance between the geometric center of the target (1), and the tip of the bolt (3) abutting the tank shell is predetermined and known. An adequate bolt length is selected before fabricating a set of targets for a given tank, based on the anticipated insulation thickness. Thus, in order to find the 3D coordinates of the point where the bolt (3) abuts the tank shell, the vector describing the bolt (3) needs to be added to the vector describing the position of the geometric center of the target (1). The cosines of the first vector are the same as the coefficients of the equation of the plane made by the target (1) in space. The length of the first vector is equal to the predetermined length of bolt (3). Thus, the first vector is completely determined and known. The 3D components of the second vector are given by the difference between the 3D coordinates of the geometric center of the target (1), which have already been calculated by the spreadsheet above, and the 3D coordinates of the point of location of the total station. The spreadsheet adds together the 2 vectors thus defined and provides the 3D coordinates of the respective measurement point, which is the point where the bolt (3) abuts to the tank shell.

After the 3D coordinates of each measurement point on the shell have been calculated, each set of measurement points located in the same horizontal plane is treated separately. Similar to the API method referenced above, the spreadsheet applies for each set of points the method of the sum of the least squares to find the radius and center coordinates of the circle that approximates best the measured profile. The thank wall thickness at the respective elevation is subtracted from the calculated radius. Corrections for deformation under hydraulic pressure head and thermal expansion are applied, per the equations given in the same API procedure. Then the volume of each horizontal volume increment is calculated, based on the corrected radius. These volumes are recorded in the strap chart (strapping table). Thus, this invention allows the user to obtain a strap chart for an insulated tank without removing the insulation or draining and cleaning the tank, which is an important advantage compared to the prior art. An example of a strap chart thus obtained is attached as Table 2.

The method provided by this invention also covers tanks whose horizontal sections are not round, or approximately round. In such a case, the spreadsheet is programmed to apply the method of the sum of the least square to find a square, rectangular, polygonal, elliptical, or any other type of geometrical profile that could be witnessed. Thus, a second important advantage brought by this invention versus the prior art is that it is not limited to cylindrical tanks. It enables the user to obtain an accurate strap chart for any type of insulated tank, regardless of the irregularity of its shape or profile.

Although the present invention has been described in terms of its presently preferred embodiments, it is to be understood that such disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

We claim:

1. A reflective target (1), which can penetrate through the insulation or wrapping of a tank and abut to the tank shell, consisting of
a thin flat face, of rectangular or any other convenient geometrical shape,
with a minimum of 3 reflective areas (2) incorporated on the face of the target,
the reflective areas being round or of any other convenient shape,
each reflective area being protected against glare by a cover (4),
the flat face being bored in a geometrically significant point of the figure created by the reflective areas,
with a bolt (3) of predetermined length being pulled through the hole, perpendicular to the flat face, on the backside of the flat face,
with a knurled nut (5) mating the bolt (3) and being expanded around the hole in order to attach the bolt to the insulation siding and to ensure snug contact between the bolt and the tank shell.

2. A procedure, or method, for the accurate measurement of the true dimensions and true geometric shape of an insulated, or otherwise wrapped tank, and for the subsequent calculation of the strapping table (strap chart) thereof, for any desired liquid height increment, without removing the wrapping (insulation), or draining and cleaning the tank on the inside.
